(19) United States
(12) Patent Application Publication
(10) Pub. No.: US 2021/0390544 A1
(43) Pub. Date: Dec. 16, 2021

(54) SYSTEMS AND METHODS FOR SELECTING TRANSACTION RECIPIENTS AND SENDING B2B PAYMENTS TO RECIPIENTS

(71) Applicant: Fidelity Information Services, LLC, Jacksonville, FL (US)

(72) Inventors: Hunter Terrell, Monroe, OH (US); Charles Squeri, Denver, CO (US); Curtis Knox, Parker, CO (US); Anuradha Ramakrishnan, Broomfield, CO (US); David Burrell, Aurora, CO (US); Vijay Pazhaniswamy Guru, St. Augustine, FL (US)

(73) Assignee: FIDELITY INFORMATION SERVICES, LLC, Jacksonville, FL (US)

(21) Appl. No.: 16/899,429

(22) Filed: Jun. 11, 2020

(51) Int. Cl. G06Q 20/40; G06Q 40/02; G06Q 20/10; G06F 16/9538; G06F 9/54

(52) U.S. Cl. CPC G06Q 20/405; G06Q 40/02; G06F 9/547; G06F 16/9538; G06Q 20/108

(57) ABSTRACT

Systems and methods for selecting transaction recipients and sending business-to-business (B2B) payments to recipients are disclosed. A method may include: receiving a search query; searching through a plurality of business records to identify at least one matching business record with a business profile at least partially matching the search query; providing the at least one matching business record for display to a user via a user interface; receiving a selection of an intended recipient selected from the at least one matching business record; generating at least one payment option for transferring, from the user to the intended recipient, a payment amount specified by the user; providing the at least one payment option for display to the user via the user interface; receiving a selection of one of the payment option; and processing the transferring of the payment amount from the user to the intended recipient using the selected payment option.

### TECHNICAL FIELD

The present disclosure generally relates to computerized methods and systems for processing transactions using a payment network and, more particularly, to computerized methods and systems for selecting business-to-business payment recipients and sending business-to-business payments to recipients.

### BACKGROUND

Traditional payment networks are configured to process and enable financial transactions between various financial entities and merchants through the transfer of cash having a particular cash value. The transfer of cash or traditional cash-substitutes may be accomplished using negotiable instruments and/or electronic payment means including debit cards, credit cards, electronic fund transfers, etc. Each transfer thereof may be subject to procedures and protocols of a payment network based on one or more transaction rules associated with the payment network.

A business-to-business transaction, which may also be referred to as B2B or B-to-B transaction, is a form of transaction between businesses, e.g., manufacturers, wholesalers, retailers, or service providers. Business-to-business transactions are different from transactions conducted between individual users because, among other things, business transactions reflect specific banking relationships, payment preferences, and transaction options that must be considered and accounted for in order to effectively conduct business-to-business transactions. Furthermore, unlike individual users, e.g., consumers, who typically don't know (or have no interest in knowing) the transaction costs associated with their transactions, business entities tend to be more cost conscious in deciding how to handle payment transactions. Therefore, the added complexity associated with processing business-to-business transactions results in more complicated transactions and difficult to navigate user interfaces.

Therefore, a need exists in the financial service industry to provide simplified business-to-business financial transaction interfaces. The present disclosure is directed to addressing these and other challenges.

### SUMMARY

One aspect of the present disclosure is directed to a computer-implemented system. The computer-implemented system may include a non-transitory computer-readable medium configured to store instructions and at least one processor configured to execute the instructions to perform operations. The operations may include: receiving a search query; searching through a plurality of business records to identify at least one matching business record with a business profile at least partially matching the search query; providing the at least one matching business record for display to a user via a user interface; receiving a selection of an intended recipient selected from the at least one matching business record; generating at least one payment option for transferring, from the user to the intended recipient, a payment amount specified by the user; providing the at least one payment option for display to the user via the user interface; receiving a selection of one of the at least one payment option; and processing the transferring of the payment amount from the user to the intended recipient using the selected payment option.

Yet another aspect of the present disclosure is directed to another computer-implemented system. The computer-implemented system may include a non-transitory computer-readable medium configured to store instructions and at least one processor configured to execute the instructions to perform operations. The operations include receiving a search query; searching through a plurality of business records to identify at least one matching business record with a business profile at least partially matching the search query; displaying the at least one matching business record to a user via a user interface; receiving a selection of an intended recipient selected from the at least one matching business record; generating at least one payment option for transferring, from the user to the intended recipient, a payment amount specified by the user; displaying the at least one payment option to the user via the user interface; receiving a selection of one of the at least one payment option; and submitting a request to a financial transaction system to process the transferring of the payment amount from the user to the intended recipient using the selected payment option.

Other aspects of the present disclosure are directed to computer-implemented methods for performing the functions of the computer-implemented systems discussed above.

Other systems, methods, and computer-readable media are also discussed herein.

### BRIEF DESCRIPTION OF THE DRAWINGS

FIG. 1 is a schematic diagram of an example system for processing a financial transaction, consistent with the disclosed embodiments.

FIG. 2 is a block diagram of an example server computer system for processing a financial transaction, consistent with the disclosed embodiments.

FIG. 3 is a block diagram of an example user device 106 shown in FIG. 1, consistent with the disclosed embodiments.

FIG. 4 depicts an example interface presented on an apparatus used in the system shown in FIG. 1, consistent with the disclosed embodiments.

FIG. 5 depicts an example interface presented on an apparatus used in the system shown in FIG. 1, consistent with the disclosed embodiments.

FIG. 6 depicts an example interface presented on an apparatus used in the system shown in FIG. 1, consistent with the disclosed embodiments.

FIG. 7 depicts an example interface presented on an apparatus used in the system shown in FIG. 1, consistent with the disclosed embodiments.

FIG. 8 depicts an example interface presented on an apparatus used in the system shown in FIG. 1, consistent with the disclosed embodiments.

FIG. 9 is a flowchart of an example process for selecting a payment recipient and sending business-to-business payment to the recipient, consistent with the disclosed embodiments.

FIG. 10 is a flowchart of an example process for selecting a payment recipient and sending business-to-business payment to the recipient, consistent with the disclosed embodiments.

### DETAILED DESCRIPTION

The disclosed embodiments include systems and methods for processing financial transactions. Before explaining certain embodiments of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the accompanying drawings, are for the purpose of description and should not be regarded as limiting.

As such, those skilled in the art will appreciate that the conception upon which this disclosure is based may readily be utilized as a basis for designing other structures, methods, and systems for carrying out the several purposes of the present disclosure.

Reference will now be made in detail to the present example embodiments of the disclosure, examples of which are illustrated in the accompanying drawings. Wherever possible, the same reference numbers will be used throughout the drawings to refer to the same or like parts.

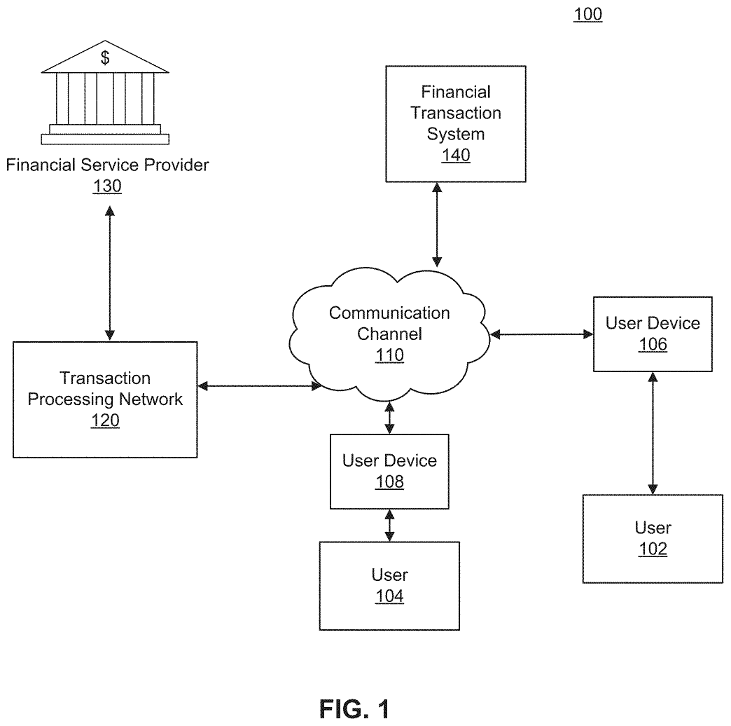

FIG. 1 is a schematic diagram illustrating an example system 100 for processing a financial transaction, consistent with the disclosed embodiments. For example, the financial transaction processed by system 100 may be in the form of check payments, debit card payments, credit card payments, electronic payment made through the Automated Clearing House (ACH) Network, Real-Time Payment Network, wire transfers, electronic payments, peer-to-peer payments, mobile payments, electronic fund payment, or the like. Moreover, the payments processed by system 100 may include recurring payments, such as payments of utility bills, payments to contractors, service providers, product suppliers, and the like. As shown in FIG. 1, system 100 may include one or more transaction processing network 120, financial service provider 130, financial transaction system 140, and user devices 106, 108. In some embodiments, transaction processing network 120, financial service provider 130, financial transaction system 140, and user devices 106, 108 may communicate via one or more communication channels 110.

A communication channel 110 may include a bus, a cable, a wireless communication channel, a radio-based communication channel, the Internet, a local area network (LAN), a wireless local area network (WLAN), a wide area network (WAN), a cellular communication network, or any Internet Protocol (IP), Secure Shell (SSH), or Hypertext Transfer Protocol (HTTP) based communication network and the like. In some embodiments, communication channel 110 may be based on public cloud infrastructure, private cloud infrastructure, hybrid public/private cloud infrastructure, or no cloud infrastructure. In such differing embodiments, transaction processing network 120, financial service provider 130, financial transaction system 140, and user devices 106, 108 may be in the same, or in different, networks or network segments.

Transaction processing network 120 may include one or more computer systems associated with one or more financial entities, such as a financial service provider 130. In some embodiments, transaction processing network 120 may include an Interbank Network (such as NYCE®, INTERAC®, or the like). In some embodiments, transaction processing network 120 may enable the use of ATM cards issued by a bank to be used. In some embodiments, transaction processing network 120 may provide transaction processing services between business entities, e.g., business entity 102 or 104, and one or more financial service provider 130 through financial transaction system 140, including transactions such as deposits, withdraws, transfers, and the like. Consistent with the present disclosure, business entities may include, e.g., organizations, corporations, partnerships, limited liability companies, sole proprietorships, as well as users, employees, agents, etc. acting on behalf of their respective business entities. Also consistent with the present disclosure, transaction processing network 120 may receive one or more requests for processing transactions initiated by business entity 102 or 104 (e.g., by a card swipe, a mobile payment, an online payment, or the like) or financial transaction system 140. In the disclosed embodiments, transaction processing network 120 may be developed and operated by a third-party service provider authorized by financial service provider 130 to process financial transactions. In other embodiments, transaction processing network 120 may be associated with one or more financial service provider 130 for processing financial transactions.

Transaction processing network 120 may include one or more components that perform processes consistent with the disclosed embodiments. For example, transaction processing network 120 may include one or more computers (e.g., server computers, database systems, etc.) that execute software instructions programmed to perform aspects of the disclosed embodiments, such as collecting data regarding transaction requests, processing transaction requests according to one or more transaction rules, processing authentication requests, authorizing transactions, transmitting authorization responses, or settling completed financial transactions.

In some embodiments, transaction processing network 120 may provide a connectivity infrastructure for enabling communications among the various entities and financial transaction system 140 and for processing transactions and/or payment transfers. In some embodiments, transaction processing network 120 may be implemented as part of or in conjunction with a Local Area Network (LAN) or a Wide Area Network (WAN) (such as the internet), and may be a single network or a combination of networks. In some embodiments, transaction processing network 120 may be implemented as a single type of network or a combination of different types of networks (e.g., networks for wireline and/or wireless communications). In some embodiments, transaction processing network 120 may also utilize cloud computing technologies (e.g., for storage, caching, or the like). In some embodiments, transaction processing network 120 can be national, international, or both. It should be noted that transaction processing network 120 is not limited to the above examples, and system 100 may implement any type of network that allows the entities (shown and not shown) included in FIG. 1 to exchange data and information.

Financial service provider 130 may be an entity that provides financial services. For example, financial service provider 130 may be a bank, a check clearinghouse, or another type of financial service entity that configures, offers, provides, and/or manages financial service accounts, such as checking accounts, savings accounts, debit card accounts, credit card accounts, loyalty accounts, etc. These financial service accounts may be used by business entity 102 or 104 to purchase goods or services, or to make or receive payments. Financial service provider 130 may include one or more components that perform processes consistent with the disclosed embodiments. The computer systems of financial service provider 130 may be communicatively connected to computer systems in transaction processing network 120. In some embodiments, one or more components in both financial service provider 130 and transaction processing network 120 may cooperate to perform processes consistent with the disclosed embodiments.

Financial transaction system 140 may be implemented as a computer or other electronic device operable to receive payment transaction requests from one or more user devices, e.g., user devices 106 or 108. Financial transaction system 140 may include one or more of cashing systems, point of sale systems, online payment systems, or the like. For example, a processor associated with financial transaction system 140 may receive a transaction request from a user device, e.g., user device 106 associated with business entity 102, through an application program interface (API). The received transaction request may indicate that business entity 102 wishes to initiate an electronic payment to another business entity, e.g., business entity 104.

In some embodiments, the transaction request between business entities 102 and 104 may be referred to as a business-to-business transaction request. For example, business entity 102 may be a retailer and business entity 104 may be one of the retailer's service providers or product suppliers. An employee, agent, etc. of business entity 102 may initiate an electronic payment using user device 106, which may be installed with an application that can be used to initiate a payment or fund transfer. User device 106 may be a mobile phone, a personal computer, a wearable device (e.g., a smartwatch, smart glasses, etc.), a messaging device, a gaming console, a tablet computer, a personal digital assistant, or the like. As will be described in more details below, in some embodiments, the application installed on user device 106 may be specifically configured to handle business-to-business transactions.

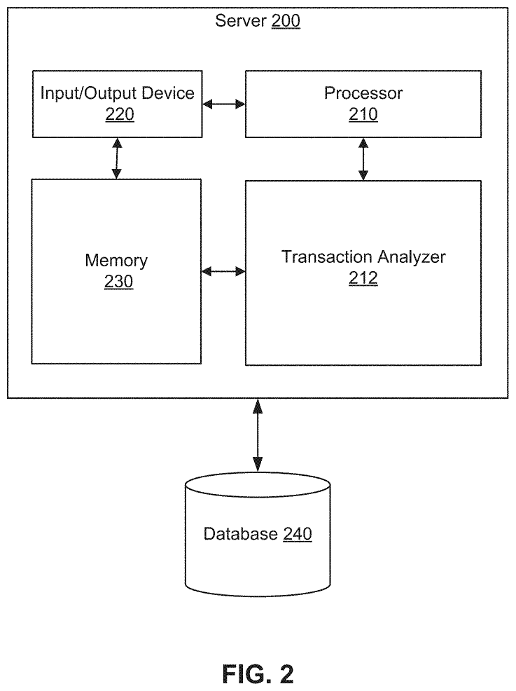

FIG. 2 is a block diagram of an example server computer system 200 (referred to as “server 200” hereinafter) used in system 100, consistent with the disclosed embodiments. For example, server 200 may be used in transaction processing network 120, financial service provider 130, or financial transaction system 140. Server 200 may be one or more computing devices configured to execute software instructions stored in memory to perform one or more processes consistent with the disclosed embodiments. For example, server 200 may include one or more memory devices for storing data and software instructions and one or more hardware processors to analyze the data and execute the software instructions to perform server-based functions and operations (e.g., back-end processes).

As shown in FIG. 2, server 200 may include a hardware processor 210, an input/output (I/O) device 220, and a memory 230. It should be noted that server 200 may include any number of those components and may further include any number of any other components. Server 200 may be standalone, or it may be part of a subsystem, which may be part of a larger system. For example, server 200 may represent distributed servers that are remotely located and communicate over a network.

Processor 210 may include or one or more known processing devices, such as, for example, a microprocessor. In some embodiments, processor 210 may include any type of single or multi-core processor, mobile device microcontroller, central processing unit, etc. In operation, processor 210 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in memory 230, processor 210, or elsewhere.

I/O device 220 may be one or more devices configured to allow data to be received and/or transmitted by server 200. I/O device 220 may include one or more customer I/O devices and/or components, such as those associated with a keyboard, mouse, touchscreen, display, etc. I/O device 220 may also include one or more digital and/or analog communication devices that allow server 200 to communicate with other machines and devices, such as other components of system 100. I/O device 220 may also include interface hardware configured to receive input information and/or display or otherwise provide output information. For example, I/O device 220 may include a monitor configured to display a customer interface.

Memory 230 may include one or more storage devices configured to store instructions used by processor 210 to perform functions related to disclosed embodiments. For example, memory 230 may be configured with one or more software instructions associated with programs and/or data.

Memory 230 may include a single program that performs the functions of the server 200, or multiple programs. Additionally, processor 210 may execute one or more programs located remotely from server 200. Memory 230 may also store data that may reflect any type of information in any format that the system may use to perform operations consistent with disclosed embodiments. Memory 230 may be a volatile or non-volatile (e.g., ROM, RAM, PROM, EPROM, EEPROM, flash memory, etc.), magnetic, semiconductor, tape, optical, removable, non-removable, or another type of storage device or tangible (i.e., non-transitory) computer-readable medium.

Server 200 may also be communicatively connected to one or more databases 240. For example, server 200 may be communicatively connected to database 240. Database 240 may be a database implemented in a computer system (e.g., a database server computer) in transaction processing network 120, financial service provider 130, or financial transaction system 140. Database 240 may include one or more memory devices that store information and are accessed and/or managed through server 200. By way of example, database 240 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, server 200 may include database 240. Alternatively, database 240 may be located remotely from the server 200. Database 240 may include computing components (e.g., database management system, database server, etc.) configured to receive and process requests for data stored in memory devices of database 240 and to provide data from database 240.

Consistent with the disclosed embodiments, server 200 may include transaction analyzer 212 configured to receive a transaction request and orchestrate financial transaction system 140 for processing the transaction request. Transaction analyzer 212 may be implemented as software (e.g., program codes stored in memory 230), hardware (e.g., a specialized chip incorporated in or in communication with processor 210), or a combination of both. Transaction analyzer 212 may be configured to communicate with financial transaction system 140 to input or output transaction data related to the electronic payment initiated by business entities, e.g., business entity 102 in the example described above. Transaction analyzer 212 may also be configured to communicate the application installed on user devices, e.g., user device 106 in the example described above, and orchestrate the application installed on user devices to provide certain user interfaces specifically configured to handle business-to-business transactions.

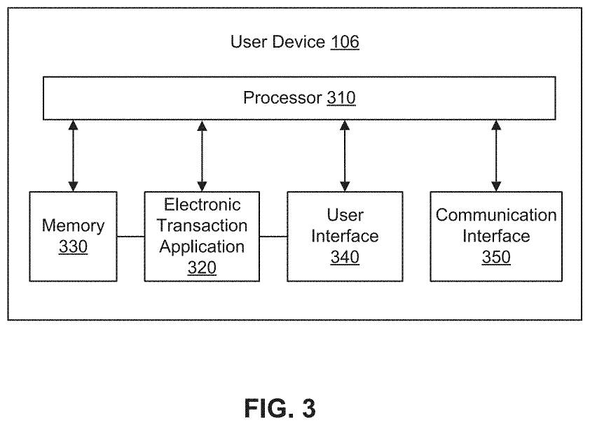

FIG. 3 is a block diagram of an example user device 106 used in system 100, consistent with the disclosed embodiments. As shown in FIG. 3, user device 106 may include a hardware processor 310, an electronic transaction application 320, a memory 330, a user interface 340, and a communication interface 350. In some embodiments, processor 310 may be similar to processor 210, and memory 330 may be similar to memory 230.

Processor 310 may include a digital signal processor, a microprocessor, or another appropriate processor to facilitate the execution of computer instructions encoded in a computer-readable medium. Processor 310 may be configured as a separate processor module dedicated to making an electronic payment. Alternatively, processor 310 may be configured as a shared processor module for performing other functions of user device 106 unrelated to the disclosed methods for making an electronic payment. In some embodiments, processor 310 may execute computer instructions (e.g., program codes) stored in memory 330, and may perform functions in accordance with example techniques described in this disclosure.

Memory 330 may include any appropriate type of mass storage provided to store information that processor 310 may need to operate. Memory 330 may be a volatile or non-volatile, magnetic, semiconductor, tape, optical, removable, non-removable, or another type of storage device or tangible (i.e., non-transitory) computer-readable medium including, but not limited to, a ROM, a flash memory, a dynamic RAM, and a static RAM. Memory 330 may be configured to store one or more computer programs that may be executed by processor 310 to perform the disclosed functions for making an electronic payment.

Electronic transaction application 320 may be a module dedicated to performing functions related to initiating an electronic transaction (e.g., a payment or fund transfer). Electronic transaction application 320 may be configured as hardware, software, or a combination thereof. For example, electronic transaction application 320 may be implemented as computer code stored in memory 330 and executable by processor 310. As another example, electronic transaction application 320 may be implemented as a special-purpose processor, such as an application-specific integrated circuit (ASIC), dedicated to make an electronic payment. As yet another example, electronic transaction application 320 may be implemented as an embedded system or firmware, and/or as part of a specialized computing device.

User interface 340 may include a graphical interface (e.g., a display panel), an audio interface (e.g., a speaker), or a haptic interface (e.g., a vibration motor). For example, the display panel may include a liquid crystal display (LCD), a light-emitting diode (LED), a plasma display, a projection, or any other type of display. The audio interface may include microphones, speakers, and/or audio input/outputs (e.g., headphone jacks).

User interface 340 may also be configured to receive input or commands from business entity 102. For example, the display panel may be implemented as a touch screen to receive input signals from an employee, agent, etc. of business entity 102. The touch screen includes one or more touch sensors to sense touches, swipes, and other gestures on or near the touch screen. The touch sensors may sense not only a boundary of a touch or swipe action but also a period of time and a pressure associated with the touch or swipe action. Alternatively, or additionally, user interface 340 may include other input devices such as keyboards, buttons, joysticks, and/or trackballs. User interface 340 may be configured to send the input to processor 310 and/or electronic transaction application 320.

Communication interface 350 can access a communication channel (e.g., communication channel 110) based on one or more communication standards, including wireless communication standards such as WiFi, LTE, 2G, 3G, 4G, 5G, etc. In some embodiments, communication interface 350 may include a near field communication (NFC) module to facilitate short-range communications between user device 106 and other devices. In other embodiments, communication interface 350 may be implemented based on radio-frequency identification (RFID) technology, an infrared data association (IrDA) technology, an ultra-wideband (UWB) technology, a Bluetooth® technology, or other technologies.

In some embodiments, business entity 102 may use user device 106 to initiate an electronic payment to business entity 104. Business entity 102 may be referred to as a sender and business entity 104 may be referred to as a recipient. For example, in one embodiment, processor 310 or electronic transaction application 320 may display, on user interface 340, payment information (e.g., a recipient's name, a payment amount, a date, etc.) for business entity 102 to review and confirm (e.g., by pressing a button provided on user interface 340, entering authentication information, biometric authentication, or the like). When payment information is confirmed, processor 310 may send transaction data via communication interface 350 to server 200 (e.g., through financial transaction system 140 or communication channel 110) for processing. Server 200 may also authenticate (e.g., by transaction analyzer 212) the payment information included in the transaction data and authorize the payment to business entity 104.

With server 200 as shown and described in FIG. 2 and user device as shown and described in FIG. 3, this disclosure provides systems and methods for facilitating the identification and/or selection of payment recipients and sending of business-to-business payments to such recipients. Business-to-business payments are different from payments made between individual users because, among other things, business transactions reflect specific banking relationships, payment preferences, and transaction options that must be considered and accounted for in order to effectively conduct business-to-business transactions. Furthermore, unlike individual users, e.g., consumers, who typically don't know or have no interest in knowing the transaction costs associated with their transactions, business entities tend to be more cost conscious in deciding how to handle payment transactions. This disclosure provides a simplified business-to-business financial transaction interface for display on user interface 340 to help senders identify and select payment recipients and to facilitate business-to-business transactions between senders and recipients.

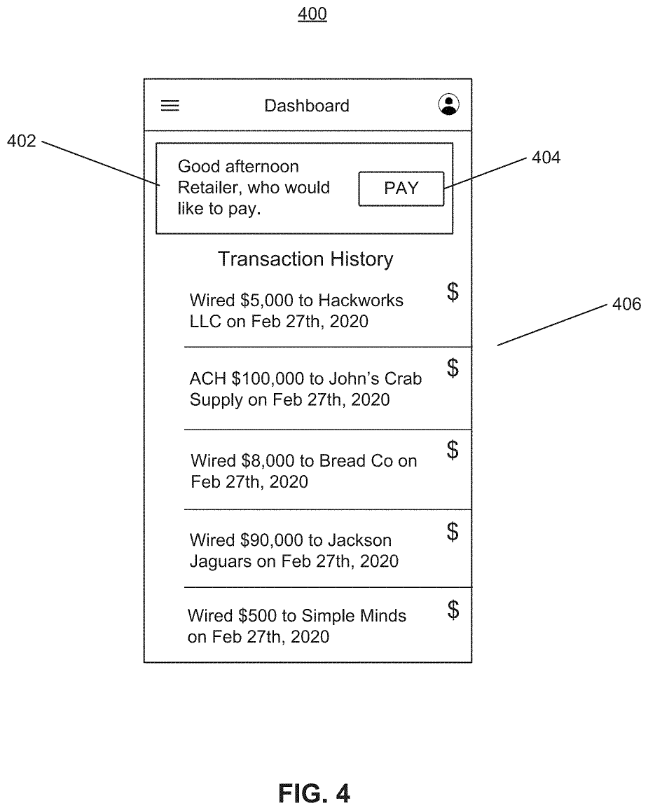

Referring now to FIGS. 4-8, these figures depict example interfaces 400-700 that may be presented on user device 106 consistent with the disclosed embodiments. For example, user device 106 may be a smartphone or a computer used by an employee of a business user, e.g., business entity 102 (who may also be referred to as the sender), for sending a payment to another business user, e.g., business entity 104 (who may also be referred to as the recipient). In some embodiments, interfaces 400-700 may be driven by electronic transaction application 320 and displayed on user interface 340 (e.g., a display panel or a touchscreen) of user device 106. In some embodiments, interfaces 400-700 may be provided as a part of a user interface of a stand-alone application. Alternatively, in some embodiments, interfaces 400-700 may be embedded into other applications.

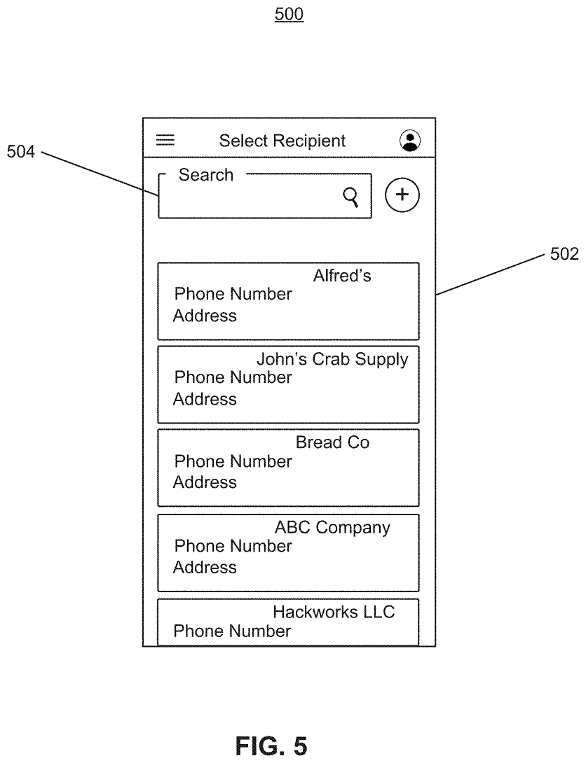

As shown in FIG. 4, business entity 102 may be a business named “Retailer.” In some embodiments, a greeting message 402 identifying the business may be displayed. Alternatively, or additionally, greeting message 402 may greet a specific employee of the business who is operating user device 106. In some embodiments, interface 400 may present business entity 102 with a pay button 404 and a transaction history 406. Engaging pay button 404 may take business entity 102 to a payment interface 500 depicted in FIG. 5.

Interface 500 may present business entity 102 with a list of probable recipients 502. In some embodiments, electronic transaction application 320 may determine the list of probable recipients 502 and provide the list for display on interface 500. In some embodiments, electronic transaction application 320 may adapt to user behaviors and may utilize various types of machine learning techniques to generate the list of probable recipients 502. In some embodiments, electronic transaction application 320 may also rank or sort the list of probable recipients 502 so that the probable recipients can be presented to business entity 102 based on their corresponding probabilities of being selected by business entity 102. It is contemplated that electronic transaction application 320 may rank the probable recipients based on factors including, e.g., frequency, recency, outstanding balance, approaching due dates, reoccurring due dates, and the like.

In some embodiments, interface 500 may also present business entity 102 with a search box 504. Business entity 102 may enter a search query into search box 504 to search for an intended recipient. The search query may include business profile information such as name, address, phone number, etc. Electronic transaction application 320 may receive the search query entered by business entity 102 and provide the search query to one or more transaction processing network 120, financial service provider 130, or financial transaction system 140. In some embodiments, one of electronic transaction application 320, transaction processing network 120, financial service provider 130, or financial transaction system 140 may be configured to process the search query entered by business entity 102.

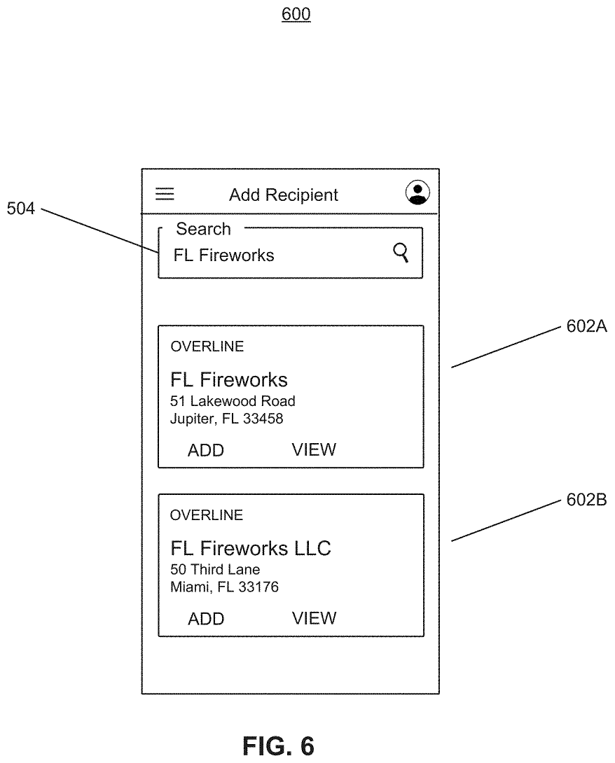

For example, in some embodiments, financial transaction system 140 may have established working relationships with various financial service providers 130 or otherwise have direct or indirect access to records of businesses having accounts with the various financial service providers 130. Alternatively, or additionally, financial transaction system 140 may provide financial transaction services directly to various businesses and may have access to records of such businesses in its own customer database. Electronic transaction application 320 may provide the search query entered by business entity 102 to financial transaction system 140, which may attempt to identify one or more business records with profiles at least partially matching the search query. Financial transaction system 140 may return the matching records to electronic transaction application 320, which may present business entity 102 with an interface 600 depicted in FIG. 6. As shown in FIG. 6, interface 600 may present the matching (or closes matching) records 602 to business entity 102 and may allow business entity 102 to select one of the records 602 as the intended recipient.

In some embodiments, financial transaction system 140 may be configured to create a centralized repository of business profiles based on business records accessible to financial transaction system 140. It is contemplated that creating such a repository may improve efficiency and reduce data discrepancy. In some embodiments, a business profile may include information concerning, e.g., business name, address, contact information, account information, payment preferences, banking relationships, as well as other types of transaction related information specific to that business. In some embodiments, financial transaction system 140 may also cooperate with various financial service providers 130 so that financial service providers 130 (e.g., commercial banks) may aggregate their business account information and make such information searchable to financial transaction system 140. In some embodiments, financial transaction system 140 may communicate with various financial service providers 130 through one or more APIs.

In some embodiments, financial transaction system 140 may establish (or financial service providers 130 may provide) one or more APIs to enable financial transaction system 140 to search data stores associated with financial service providers 130 for business account information based on business names, addresses, phone numbers, etc. Similarly, in some embodiments, financial transaction system 140 may establish (or financial service providers 130 may provide) one or more APIs to data stores that enable financial transaction system 140 to search for business account information based on other identifiers, such as federal tax identifiers and the like. Moreover, in some embodiments, financial service providers 130 may agree to communicate account opening and closing information to financial transaction system 140, thereby keeping the information accessible to financial transaction system 140 up to date.

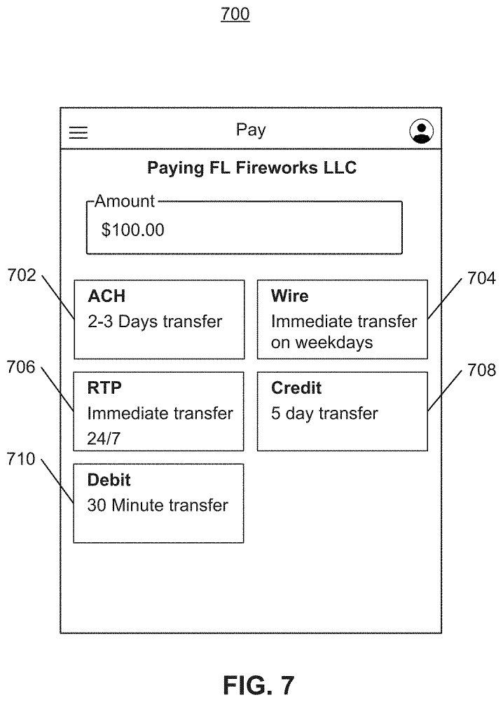

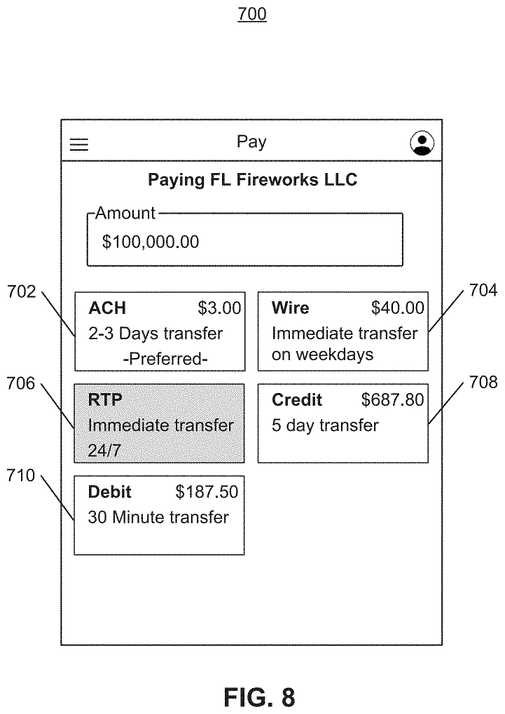

Continuing with the example using the interface depicted in FIG. 6, suppose financial transaction system 140 conducts the search for the query “FL Fireworks” and returns two matching records 602A and 602B to electronic transaction application. Upon receiving the response, electronic transaction application 320 may present the information contained in records 602A and 602B to business entity 102 via interface 600. The information presented may include, e.g., the business names, addresses, contact information and the like. It is contemplated that presenting such information may help business entity 102 identify the intended recipient. If neither of records 602A and 602B is the intended recipient, business entity 102 may use search box 504 to search again using an additional search query, e.g., using phone number instead of business name. On the other hand, if one of records 602A and 602B is the intended recipient, business entity 102 may select the intended recipient via interface 600. Upon receiving business entity 102's selection of the intended recipient, electronic transaction application 320 may present business entity 102 with an interface 700 depicted in FIG. 7 or 8.

As shown in FIG. 7, interface 700 may present business entity 102 with a list of payment options 702-710 that can be used to process the payment from business entity 102 to the intended recipient. For example, payment options may include Automated Clearinghouse (ACH) transfer, wire transfer, real-time payment (RTP), transfer from credit, and debit transfer, among others. In some embodiments, interface 700 may present payment options 702-710 to business entity 102 along with information indicating, e.g., a payment type and a payment timeline. In some embodiments, interface 700 may also display transaction costs associated with payment options 702-710, as depicted in FIG. 8.

In some embodiments, the transaction costs associated with payment options 702-710 may be dynamically determined. For example, in some embodiments, the transaction cost associated with a particular payment option may be discounted to promote that payment option, or increased when demand for that particular payment option exceeds a certain capacity threshold. Furthermore, in some embodiments, the transaction cost associated with a particular payment option may be different for different business entities depending on their business relationships with their corresponding financial service providers 130, including, e.g., banks, check clearinghouses, or other type of financial service entities. In such embodiments, electronic transaction application 320 may operate in conjunction with one or more of transaction processing network 120, financial service provider 130, or financial transaction system 140 to obtain correct pricing information for specific business entities. Additionally or alternatively, electronic transaction application 320 may obtain correct pricing information for specific business entities through API platforms, gateways, environments, etc., accessing public and/or private data ecosystems, and/or performing additional analyses using, e.g., account and relationship modeling techniques. In this manner, electronic transaction application 320 may configure interface 700 to display transaction costs associated with payment options 702-710 specific to business entity 102.

In some embodiments, electronic transaction application 320 may adapt to user behaviors and may utilize various types of machine learning techniques and/or models, including, but not limited to multivariate regression and classification trees, random forests, gradient boosted machines, neural networks and deep learners to generate payment options 702-710 for display to business entity 102. In some embodiments, electronic transaction application 320 may operate independently, or may operate in conjunction with one or more transaction processing network 120, financial service provider 130, or financial transaction system 140.

In some embodiments, electronic transaction application 320 may generate payment options 702-710 based on information concerning, e.g., business entity 102 (i.e., the sender), the sender's banking information, the sender's payment preferences (e.g., timing constraints, method of delivery, etc.), the intended recipient, the intended recipient's banking information, the intended recipient's payment preferences, payment amount, transaction cost, as well as any restrictions, limitations, or preferences imposed by the sender's bank and the intended recipient's bank. For example, if the payment amount exceeds a certain limit, then certain payment types (e.g., payment option 706 shown in FIG. 8) may be deemed unsuitable and may therefore be omitted or greyed out from the list of payment options. In another example, if the payment is subject to certain timing constraints (e.g., must be made within one business day), then payment options that would require longer processing time may be omitted or greyed out from the list of payment options. In still another example, if the intended recipient's bank only accepts certain types of transfers, then payment options that are not accepted by the intended recipient's bank may be deemed unsuitable and may therefore be omitted or greyed out from the list of payment options.

In some embodiments, electronic transaction application 320 may generate payment options 702-710 by taking into consideration information concerning the types of payment options used by business entity 102 in the past. For example, if business entity 102 frequently uses credit to handle same or similar payments in the past, electronic transaction application 320 may configure interface 700 to present a credit payment option 708 to business entity 102. It is contemplated that presenting credit payment option 708 in this manner may allow business entity 102 to continuing using the credit payment option that business entity 102 is familiar with. Additionally, it serves to inform business entity 102 about other options and provides an intuitive interface for business entity 102 to compare the various available options against each other.

Electronic transaction application 320 may also operate in conjunction with one or more transaction processing network 120, financial service provider 130, and financial transaction system 140 to determine whether the intended recipient accepts loyalty accounts or reward points as payment. Electronic transaction application 320 may make this determination based on the intended recipient's payment preferences. If the intended recipient indicates that it accepts loyalty accounts or reward points as payment, electronic transaction application 320 may configure interface 700 to present additional loyalty- and/or point-based payment options to business entity 102.

In some embodiments, electronic transaction application 320 may generate payment options 702-710 without requiring additional input from business entity 102, thereby reducing the complexity of interface 700 and improving usability of electronic transaction application 320. In such embodiments, electronic transaction application 320 may communicate with one or more transaction processing network 120, financial service provider 130, and financial transaction system 140 to obtain information needed to generate payment options 702-710. For example, as described above, financial transaction system 140 may have access to a centralized repository of business profiles or may communicate with various financial service providers 130 through one or more APIs to obtain business profiles of various businesses. Electronic transaction application 320 may therefore communicate with financial transaction system 140 to obtain information needed to generate payment options 702-710, including, e.g., routing numbers and account numbers. Nevertheless, in some embodiments, electronic transaction application 320 may still provide business entity 102 with an option to manually enter information such as routing numbers and account numbers. Business entity 102 may choose this option if, for example, business entity 102 wants to use a payment method not listed in payment options 702-710.

In some embodiments, electronic transaction application 320 may also provide one or more notifications to business entity 102 and its intended recipient, e.g., business entity 104, through their user devices 106 and 108. For example, electronic transaction application 320 may provide a notification to business entities 102 and 104 informing business entities 102 and 104 of a pending payment when business entity 102 selects one of the payment options 702-710 to send payment to business entity 104. Electronic transaction application 320 may then submit the selected payment option to one or more transaction processing network 120, financial service provider 130, or financial transaction system 140 for processing. If the payment is successfully processed, electronic transaction application 320 may provide a confirmation notification to business entities 102 and 104. If the payment is canceled or cannot be successfully processed, electronic transaction application 320 may provide an error notification to business entities 102 and 104. It is contemplated that these notifications may be audio notifications, visual notifications, or haptic notifications.

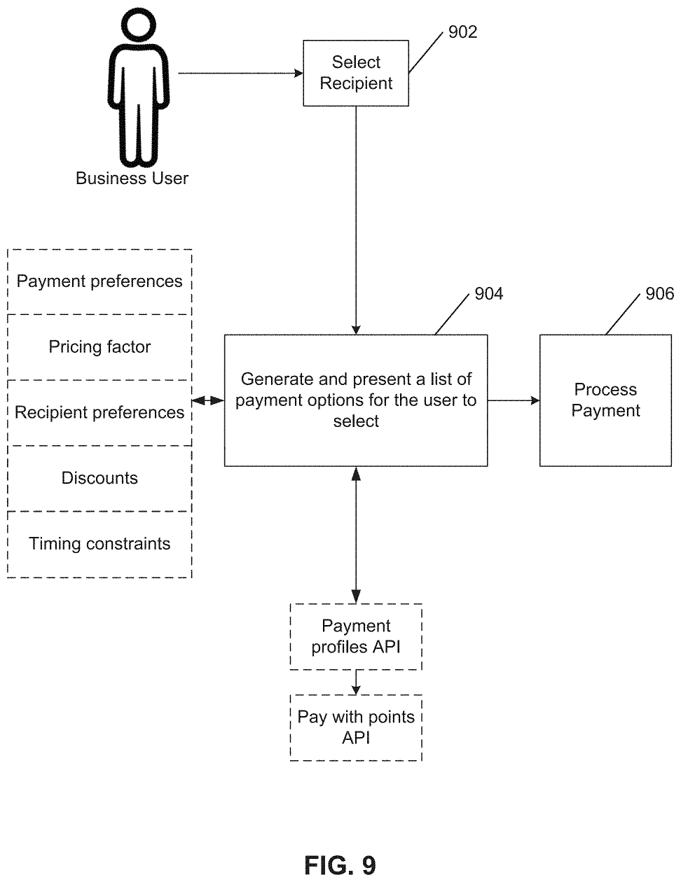

FIG. 9 is a flowchart of example process 900 for selecting and sending payment to a recipient, consistent with the disclosed embodiments. Process 900 may be a process performed by a computer-implemented system (e.g., user device 106) in system 100. The computer-implemented system may include a memory (e.g., memory 330) that stores instructions and a processor (e.g., processor 310) programmed to execute the instructions to implement process 900. Process 900 may be associated with the operations shown and described in FIGS. 4-8. For example, process 900 may be implemented as one or more software modules stored in memory 330 and executable by processor 310 (e.g., electronic transaction application 320).

At step 902, the processor may present an interface to a user (e.g., business entity 102) to facilitate a selection of a recipient. The interface may be presented in the manners described above. For example, in some embodiments, the interface may present the user with a list of probable recipients. In some embodiments, the interface may also present the user with a search box to search for an intended recipient.

At step 904, the processor may generate and present a list of payment options that can be used to process payment from the user to the intended recipient. In some embodiments, the processor may operate independently, or may operate in conjunction with one or more transaction processing network 120, financial service provider 130, and financial transaction system 140 to generate the list of payment options as described above. Furthermore, in some embodiments, the processor may operate in conjunction with one or more transaction processing network 120, financial service provider 130, and financial transaction system 140 to obtain pricing as well as loyalty account information for specific users. Additionally or alternatively, electronic transaction application 320 may obtain pricing as well as loyalty account information for specific users through API platforms, gateways, environments, etc., accessing public and/or private data ecosystems, and/or performing additional analyses using, e.g., account and relationship modeling techniques. Alternatively, or additionally, the processor may allow the user to specify payment options manually (e.g., manually specifying the routing number and account number of the intended recipient) through the user interface.

In some embodiments, the processor may generate the payment options based on information concerning, e.g., the sender, the sender's banking information, the sender's payment preferences, the intended recipient, the intended recipient's banking information, the intended recipient's payment preferences, payment amount, transaction cost, as well as any restrictions, limitations, or preferences imposed by the sender's bank and the intended recipient's bank. The processor may also take into consideration information concerning the types of payment options used by the sender in the past. The processor may further take into consideration whether the recipient accepts loyalty accounts or reward points as payment. If the recipient accepts loyalty accounts or reward points as payment, the processor may present additional loyalty- or point-based payment options to the user. The user may then select one of the payment options presented to process the payment.

At step 906, the processor may submit the payment option selected by the user to one or more transaction processing network 120, financial service provider 130, or financial transaction system 140 for processing.

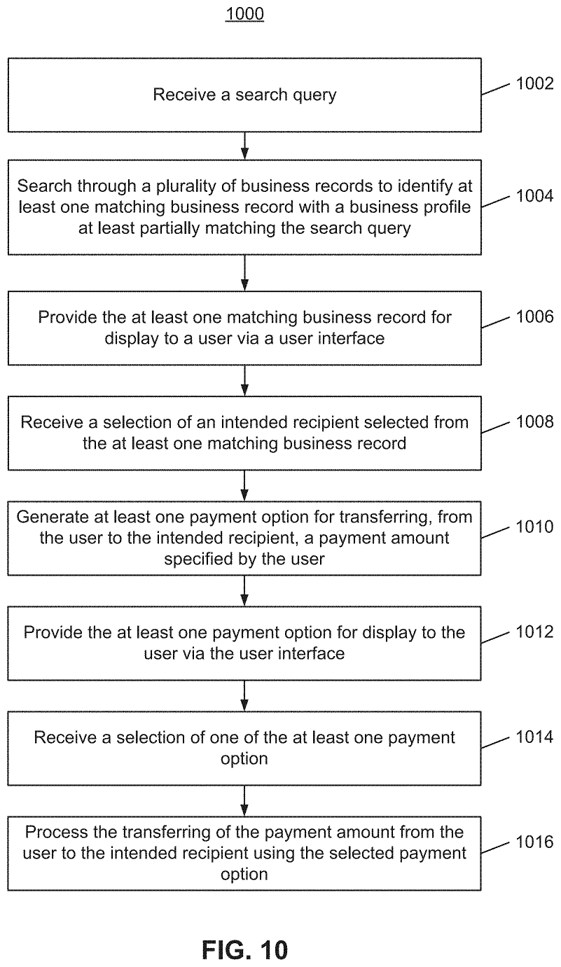

FIG. 10 is a flowchart of example process 1000 for selecting and sending payment to a recipient, consistent with the disclosed embodiments. Process 1000 may be a process performed by a computer-implemented system (e.g., server 200) in transaction processing network 120, financial service provider 130, or financial transaction system 140. The computer-implemented system may include a memory (e.g., memory 230) that stores instructions and a processor (e.g., processor 210) programmed to execute the instructions to implement process 1000. Alternatively, or additionally, process 1000 may be a process performed by a computer-implemented system (e.g., user device 106) in system 100. The computer-implemented system may include a memory (e.g., memory 330) that stores instructions and a processor (e.g., processor 310) programmed to execute the instructions to implement process 1000. Process 1000 may be associated with operations shown and described in FIGS. 4-8. For example, process 1000 may be implemented as one or more software modules (e.g., an application running on transaction analyzer 212) stored in memory 230 and executable by processor 210, or as one or more software modules stored in memory 330 and executable by processor 310 (e.g., electronic transaction application 320).

Referring to FIG. 10, at step 1002, the processor (e.g., processor 210 or 310) may receive a search query. For example, a user may enter a search query into a search box (e.g., search box 504). The search query may include business profile information such as name, address, phone number, etc. If process 1000 is performed by processor 310 of user device 106, processor 310 may receive the search query from search box 504. If process 1000 is performed by processor 210 of financial transaction system 140, processor 210 may receive the search query from processor 310.

At step 1004, the processor may search through a plurality of business records to identify at least one matching business record with a business profile at least partially matching the search query. In some embodiments, the plurality of business records may be created and maintained in a repository accessible to the processor. For example, if process 1000 is performed by processor 310 of user device 106, processor 310 may operate in conjunction with one or more transaction processing network 120, financial service provider 130, or financial transaction system 140, e.g., through APIs, to carry out the searching process. If process 1000 is performed by processor 210 of financial transaction system 140, processor 210 may create a centralized repository of business profiles based on business records accessible to financial transaction system 140. In some embodiments, a business profile may include information concerning, e.g., business name, address, contact information, account information, payment preferences, banking relationships, as well as other types of transaction related information specific to that business. In some embodiments, financial transaction system 140 may also cooperate with various financial service providers 130 so that financial service providers 130 (e.g., commercial banks) may aggregate their business account information and make such information searchable to financial transaction system 140. In some embodiments, financial transaction system 140 may communicate with various financial service providers 130 through one or more APIs. In this manner, processor 210 may access at least some of the business records through an API.

At step 1006, the processor may provide the at least one matching business record for display to a user via a user interface. For example, if process 1000 is performed by processor 310 of user device 106, processor 310 may display the at least one matching business record to a user via a user interface, e.g., interface 600. If process 1000 is performed by processor 210 of financial transaction system 140, processor 210 may send the at least one matching business record to processor 310 of user device 106 for display.

At step 1008, the processor may receive a selection of an intended recipient selected from the at least one matching business record. For example, the user may select the intended recipient via interface 600. Upon receiving the user's selection of the intended recipient, the processor may proceed to step 1010.

At step 1010, the processor may generate at least one payment option for transferring, from the user to the intended recipient, a payment amount specified by the user. As described above, in some embodiments, the processor may generate the at least one payment option based on information concerning the user, the user's banking information, the user's payment preference, the intended recipient, the intended recipient's banking information, and the intended recipient's payment preference. In some embodiments, the processor may generate the at least one payment option based on a payment amount. For example, if the payment amount exceeds a certain limit, then certain payment types may be deemed unsuitable as a possible payment option. Moreover, in some embodiment, the processor may generate the at least one payment option based on a payment date specified by the user. For example, if the payment is subject to certain timing constraints (e.g., must be made within one business day), then payment options that would require longer processing time may be deemed unsuitable as a possible payment option.

Furthermore, in some embodiment, the processor may generate the at least one payment option based on restrictions, limitations, or preferences imposed by a bank associated with at least one of the user or the intended recipient. For example, if the intended recipient's bank only accepts certain types of transfers, then payment options that are not accepted by the intended recipient's bank may be deemed unsuitable as possible payment options. In some embodiment, the processor may also generate the at least one payment option based on payment options previously used by the user. For example, if the user frequently uses a particular payment option to handle same or similar payments in the past, then that particular payment option may continue to be included as a payment option for the user.

At step 1012, the processor may provide the at least one payment option for display to the user via the user interface. For example, if process 1000 is performed by processor 310 of user device 106, processor 310 may display the at least one payment option to the user via a user interface, e.g., interface 700. If process 1000 is performed by processor 210 of financial transaction system 140, processor 210 may send the at least one payment option to processor 310 of user device 106 for display. In some embodiments, the processor may also indicate whether any payment option has been deemed unsuitable for processing the transferring of the payment. For example, in some embodiment, unsuitable payment options may be greyed out when displayed to the user.

In some embodiments, the processor may provide the at least one payment option along with a payment timeline associated with each of the at least one payment option for display to the user via the user interface, as shown in the example depicted in FIG. 7. In some embodiments, the processor may provide the at least one payment option along with a transaction cost associated with each of the at least one payment option for display to the user via the user interface, as shown in the example depicted in FIG. 8. In some embodiments, transaction costs associated with the payment options may be dynamically determined. For example, in some embodiments, the transaction cost associated with a particular payment option may be discounted to promote that payment option, or increased when user demand for that particular payment option exceeds a certain capacity threshold. Furthermore, in some embodiments, the transaction cost associated with a particular payment option may be different for different users depending on their business relationships with their corresponding financial service providers, including, e.g., banks, check clearinghouses, or other type of financial service entities.

At step 1014, the processor may receive a selection of one payment option. For example, the user may select a payment option displayed on the user interface (e.g., interface 700). Upon receiving the user's selection of the payment option, the processor may proceed to step 1016.

At step 1016, the processor may process the transferring of the payment amount from the user to the intended recipient using the selected payment option. For example, if process 1000 is performed by processor 310 of user device 106, processor 310 may submit a request to a financial transaction system, e.g., financial transaction system 140, to process the transferring of the payment amount from the user to the intended recipient using the selected payment option. If process 1000 is performed by processor 210 of financial transaction system 140, processor 210 may process the payment transfer as requested.

Consistent with disclosed embodiments, a non-transitory computer-readable medium may be provided that stores instructions for a processor (e.g., processor 210 or 310) for processing a financial transaction according to the example flowcharts of FIGS. 9-10 above. For example, the instructions stored in the non-transitory computer-readable medium may be executed by the processor for performing process 900 or 1000 in part or in entirety. Common forms of non-transitory media include, for example, a floppy disk, a flexible disk, hard disk, solid-state drive, magnetic tape, or any other magnetic data storage medium, a Compact Disc Read-Only Memory (CD-ROM), any other optical data storage medium, any physical medium with patterns of holes, a Random Access Memory (RAM), a Programmable Read-Only Memory (PROM), and Erasable Programmable Read-Only Memory (EPROM), a FLASH-EPROM or any other flash memory, Non-Volatile Random Access Memory (NVRAM), a cache, a register, any other memory chip or cartridge, and networked versions of the same.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computer-implemented system comprising:
a non-transitory computer-readable medium configured to store instructions; and
at least one processor configured to execute the instructions to perform operations comprising:
receiving a search query;
searching through a plurality of business records to identify at least one matching business record with a business profile at least partially matching the search query;
providing the at least one matching business record for display to a user via a user interface;
receiving a selection of an intended recipient selected from the at least one matching business record;
generating at least one payment option for transferring, from the user to the intended recipient, a payment amount specified by the user;
providing the at least one payment option for display to the user via the user interface;
receiving a selection of one of the at least one payment option; and
processing the transferring of the payment amount from the user to the intended recipient using the selected payment option.

2. The computer-implemented system of claim 1, wherein the plurality of business records is created and maintained in a repository accessible to the at least one processor.

3. The computer-implemented system of claim 2, wherein the repository is a centralized repository.

4. The computer-implemented system of claim 1, wherein at least a portion of the plurality of business records is accessible to the at least one processor through an application program interface (API).

5. The computer-implemented system of claim 1, wherein the business profile comprises information concerning name, address, contact information, account information, payment preference, banking relationship, or transaction related information specific to a business.

6. The computer-implemented system of claim 1, wherein the generating the at least one payment option further comprises:
generating the at least one payment option based on information concerning the user, the user's banking information, the user's payment preference, the intended recipient, the intended recipient's banking information, and the intended recipient's payment preference.

7. The computer-implemented system of claim 6, wherein the generating the at least one payment option further comprises:
generating the at least one payment option based on the payment amount.

8. The computer-implemented system of claim 6, wherein the generating the at least one payment option further comprises:
generating the at least one payment option based on a payment date specified by the user.

9. The computer-implemented system of claim 6, wherein the generating the at least one payment option further comprises:
generating the at least one payment option based on restrictions, limitations, or preferences imposed by a bank associated with at least one of the user or the intended recipient.

10. The computer-implemented system of claim 6, wherein the generating the at least one payment option further comprises:
generating the at least one payment option based on payment options previously used by the user.

11. The computer-implemented system of claim 1, wherein the providing the at least one payment option for display to the user via the user interface further comprises:
providing the at least one payment option along with a payment timeline associated with each of the at least one payment option for display to the user via the user interface.

12. The computer-implemented system of claim 11, wherein the providing the at least one payment option for display to the user via the user interface further comprises:
providing the at least one payment option along with a transaction cost associated with each of the at least one payment option for display to the user via the user interface.

13. The computer-implemented system of claim 1, wherein the providing the at least one payment option for display to the user via the user interface further comprises:
indicating whether any of the at least one payment option is unsuitable for processing the transferring of the payment amount from the user to the intended recipient.

14. A computer-implemented system comprising:
a non-transitory computer-readable medium configured to store instructions; and
at least one processor configured to execute the instructions to perform operations comprising:
receiving a search query;
searching through a plurality of business records to identify at least one matching business record with a business profile at least partially matching the search query;
displaying the at least one matching business record to a user via a user interface;
receiving a selection of an intended recipient selected from the at least one matching business record;
generating at least one payment option for transferring, from the user to the intended recipient, a payment amount specified by the user;
displaying the at least one payment option to the user via the user interface;
receiving a selection of one of the at least one payment option; and
submitting a request to a financial transaction system to process the transferring of the payment amount from the user to the intended recipient using the selected payment option.

15. The computer-implemented system of claim 14, wherein the at least one processor is configured to execute in conjunction with the financial transaction system to perform the searching of the at least one matching business record and the generating of the at least one payment option.

16. The computer-implemented system of claim 14, wherein the business profile comprises information concerning name, address, contact information, account information, payment preference, banking relationship, or transaction related information specific to a business.

17. The computer-implemented system of claim 14, wherein the generating the at least one payment option further comprises:
generating the at least one payment option based on information concerning the user, the user's banking information, the user's payment preference, the intended recipient, the intended recipient's banking information, and the intended recipient's payment preference.

18. The computer-implemented system of claim 17, wherein the generating the at least one payment option further comprises:
generating the at least one payment option based on the payment amount.

19. The computer-implemented system of claim 17, wherein the generating the at least one payment option further comprises:
generating the at least one payment option based on a payment date specified by the user.

20. The computer-implemented system of claim 17, wherein the generating the at least one payment option further comprises:
generating the at least one payment option based on restrictions, limitations, or preferences imposed by a bank associated with at least one of the user or the intended recipient.

21. The computer-implemented system of claim 17, wherein the generating the at least one payment option further comprises:
generating the at least one payment option based on payment options previously used by the user.

22. The computer-implemented system of claim 14, wherein the displaying the at least one payment option to the user via the user interface further comprises:
displaying the at least one payment option with a payment timeline associated with each of the at least one payment option to the user via the user interface.

23. The computer-implemented system of claim 22, wherein the displaying the at least one payment option to the user via the user interface further comprises:
displaying the at least one payment option with a transaction cost associated with each of the at least one payment option for display to the user via the user interface.

24. The computer-implemented system of claim 14, wherein the displaying the at least one payment option to the user via the user interface further comprises:
indicating whether any of the at least one payment option is unsuitable for processing the transferring of the payment amount from the user to the intended recipient.

25. A computer-implemented method comprising:
receiving a search query;
searching through a plurality of business records to identify at least one matching business record with a business profile at least partially matching the search query;
providing the at least one matching business record for display to a user via a user interface;
receiving a selection of an intended recipient selected from the at least one matching business record;
generating at least one payment option for transferring, from the user to the intended recipient, a payment amount specified by the user;
providing the at least one payment option for display to the user via the user interface;
receiving a selection of one of the at least one payment option; and
processing the transferring of the payment amount from the user to the intended recipient using the selected payment option.

26. A computer-implemented method comprising:
receiving a search query;
searching through a plurality of business records to identify at least one matching business record with a business profile at least partially matching the search query;
displaying the at least one matching business record to a user via a user interface;
receiving a selection of an intended recipient selected from the at least one matching business record;
generating at least one payment option for transferring, from the user to the intended recipient, a payment amount specified by the user;
displaying the at least one payment option to the user via the user interface;
receiving a selection of one of the at least one payment option; and
submitting a request to a financial transaction system to process the transferring of the payment amount from the user to the intended recipient using the selected payment option.
